(19) United States
(12) Patent Application Publication
(10) Pub. No.: US 2023/0065692 A1
(43) Pub. Date: Mar. 2, 2023

(54) Electrolyte Solution

(71) Applicant: Texture Jet Ltd, Nottingham, Nottinghamshire (GB)

(72) Inventors: Jonathon MITCHELL-SMITH, Nottingham, Nottinghamshire (GB); Alistair SPEIDEL, Nottingham, Nottinghamshire (GB); Ivan BISTEROV, Nottingham, Nottinghamshire (GB)

(21) Appl. No.: 17/796,806

(22) PCT Filed: Jan. 20, 2021
(86) PCT No.: PCT/GB2021/050116

§ 371 Date: Aug. 1, 2022

(30) Foreign Application Priority Data
Feb. 5, 2020 (GB) 2001533.5

(51) Int. Cl. B23H 3/08; B23H 3/10; B23H 3/04; C25F 3/06; C25F 3/08; C25F 3/24; C25F 3/26

(52) U.S. Cl. CPC B23H 3/08; B23H 3/10; B23H 3/04; C25F 3/06; C25F 3/08; C25F 3/24; C25F 3/26; B23H 9/008

(57) ABSTRACT

An electrolyte solution is provided for an electrochemical machining process. The electrolyte solution includes a substantially water free ionic solvent, an ionisable material in the form of an inorganic salt; and a viscosity modifier. The electrolyte has a viscosity in the range of 1 to 50 mPa·s at 20° C.

### FIELD

The present teachings relate to an electrolyte solution and to an electrochemical machining process.

### BACKGROUND

Electrochemical machining, e.g. electrochemical jet processing, is a process for selectively machining a surface of a workpiece. This is done by applying a voltage between a part, e.g. a nozzle, of an electrochemical machining device and the surface to be machined, whilst dispensing a stream or jet of electrolyte from the nozzle towards the surface. This machining method enables surfaces to be machined via an electrochemical reaction, such that it is possible to machine a surface as long as the surface material is conductive. This machining process enables a surface to be roughened, e.g. to improve bonding/attachment of components or surface coatings. This machining can also modify the optical and/or tribological properties of a surface, and polish the material surface.

A machining media (i.e. an electrolyte solution) is required in electrochemical processing techniques in order to enable ionic transfer. This ionic transfer enables materials to be added to, or removed from, a target surface.

These machining media are traditionally aqueous electrolytes. However, these may present problems when used in some electrochemical machining processes, as they can cause some metals and alloys, such as titanium and steel, to form passivated surfaces during the electrochemical machining process. This may lead to a lower machining precision and a reduced ability to texture these surfaces repeatable fashion.

Existing non-water based electrolyte solutions typically have high viscosities and are utilised in bath type electrochemical machining systems. Such electrolyte solutions are unsuitable to be jetted towards the surface of a workpiece, because of their high viscosity. These traditional non-aqueous electrolyte solutions have been limited to applications such as metal deposition and metal polishing, as the conductivity of these solutions is generally poor (deposition and polishing require low current density levels in comparison electrochemical machining processes).

The present teachings seek to overcome or at least mitigate one or more problems associated with the prior art.

### SUMMARY

According to a first aspect there is provided an electrolyte solution for an electrochemical machining process, the electrolyte solution comprising: a substantially water free ionic solvent; an ionisable material in the form of an inorganic salt; and a viscosity modifier, wherein the electrolyte comprises a viscosity in the range of 1 to 50 mPa·s at 20° C.

The viscosity modifier may comprise a water-based inorganic salt solution.

The viscosity modifier may be a concentrated water based inorganic salt solution.

The viscosity modifier may be a saturated water-based inorganic salt solution.

The concentration of the saturated solution may be at or close to the saturation point of the water-based inorganic salt solution. The concentration of the water-based salt solution may be approximately at the saturation point.

The concentration of the water-based inorganic salt solution may be in the range 80-100% of the concentrated solution. The concentration of the water-based inorganic salt solution may be in the range 90-10% of the concentrated solution. The concentration of the water-based inorganic salt solution may be in the range 95-100% of the concentrated solution.

The inorganic salt water solution may be of a molar concentration in the range of 0.1M to 5M. The inorganic salt water solution may be of a molar concentration in the range of 1M to 5M.

The concentration of the viscosity modifier in the electrolyte solution may be less than 50 wt. %, optionally wherein the concentration of the viscosity modifier in the electrolyte solution is in the range 20 to 40 wt. %, for example approximately 30 wt. %.

The concentration of the substantially water free ionic solvent may be at least 50 wt. %, optionally at least 60 wt. %, for example approximately 70 wt. %.

The ionisable may comprise compounds of the formula MX, where M may be selected from Na+, K+, Ca2+, Mg2+, Cu2+ and Zn2+, or combinations thereof, and X may be selected from F—, Cl—, Br—, I—, NO3- and SO42-, or combinations thereof.

The substantially water free solvent may comprise a polyol.

The substantially water free solvent may be selected from ethylene glycol, glycerol, methanol, ethanol, 1-propanol, 2-propanol and/or propylene glycol.

The substantially water free solvent may be selected from ethylene glycol and/or glycerol.

The substantially water free solvent may comprise a quaternary ammonium salt.

The quaternary ammonium salt may be selected from one or more of choline chloride, tetraethylammonium chloride and/or tetramethylammonium chloride.

The substantially water free solvent may be a deep eutectic solvent comprising ethylene glycol and choline chloride.

The substantially water free ionic solvent may comprise a ratio of choline chloride to ethylene glycol in the range 1:2 to 1:5.

The substantially water free ionic may comprise a ratio of choline chloride to ethylene glycol of approximately 1:3.

The pH of the electrolyte solution may be in the range of 5 to 9.

The electrolyte may comprise a viscosity in the range 5 to 30 mPa·s at 20° C., optionally wherein the electrolyte comprises a viscosity in the range 10 to 15 mPa·s at 20° C.

The electrolyte solution may comprise an electrical conductivity of at least 10 mS/cm.

The electrolyte solution may comprise an electrical conductivity in the range 10 mS/cm to 40 mS/cm, optionally wherein the electrolyte solution comprises a conductivity in the range 20 mS/cm to 30 mS/cm.

According to a second aspect there is provided an electrochemical machining process for machining a surface of a workpiece using an electrochemical machining device comprising a nozzle configured for dispensing a jet of an electrolyte solution towards a surface of a workpiece, the electrochemical machining process comprising the steps of: dispensing a jet of an electrolyte solution according to any preceding claim from a nozzle of an electrochemical machining device towards a surface of a workpiece; and applying a charge to a nozzle of an electrochemical machining device and applying a charge to a surface of a workpiece such that the nozzle and said surface define first and second electrodes of an electrolytic cell.

The process may apply a current density below 400 A/cm2, optionally below 150 A/cm2, optionally below 100 A/cm2, for example in the range of 25 to 100 A/cm2.

### BRIEF DESCRIPTION OF THE DRAWINGS

Embodiments will now be described with reference to the accompanying drawings, in which:

FIG. 1 shows an electrochemical machining device according to an embodiment including a base unit and a machining unit, where the machining unit is operated by a user; and

FIG. 2 is a schematic view of the electrochemical machining device of FIG. 1.

### DETAILED DESCRIPTION OF EMBODIMENT(S)

The present teachings relate to an electrolyte solution for the electrochemical machining, polishing and or etching of metals.

The electrolyte solution is capable of being ejected (e.g. jetted) from a nozzle towards the surface of a workpiece and possesses a sufficiently high electrolytic conductivity to carry ‘high’ currents (e.g. in excess of 1 A) through a nozzle. The nozzle may be for example a 1 mm circular nozzle. In alternative arrangements, the nozzle may be configured to a substantially rectangular nozzle, e.g. having a width of at least 5 mm or 10 mm and having a depth of approximately 0.2 mm. It will be appreciated that the size and geometry of the nozzle may be varied to suit the application.

The electrolyte solution of the present teachings has been found to produce less passivation of metal surfaces (e.g. titanium, titanium alloys, steel, iron etc.) during electrochemical machining, which enables a visibly smoother machined surface to be produced when compared to water-salt electrolytes.

One embodiment of the electrolyte solution provides for a substantially water free ionic solvent, an ionisable material in the form of an organic salt, and a viscosity modifier.

The electrolyte solution comprises a viscosity in the range of 1 to 50 mPa·s at 20° C. The electrolyte solution may comprise a viscosity in the range 5 to 40 mPa·s at 20° C., often 5 to 30 mPa·s at 20° C., often 5 to 20 mPa·s at 20° C., often 10 to 15 mPa·s at 20° C., often 15 to 20 mPa·s at 20° C.

The substantially water free ionic solvent may be considered to be an anhydrous solvent. The substantially water free solvent may include solvents having a small level of water. For example, the substantially water free solvent may include up to 1 wt. % of water, often up to 0.5 wt. % of water, for instance up to 0.1 wt. % of water (i.e. in the range 0-1 wt. %, often 0.01-0.5 wt. %, or 0.05-0.1 wt. %).

The substantially water free ionic solvent may be a polyol. Polyols particularly suitable for use in the electrochemical machining electrolyte solution are ethylene glycol and glycerol, or a combination thereof.

In one embodiment, the substantially water free solvent comprises ethylene glycol. Ethylene glycol has a lower viscosity at room temperature than other potential solvents, and so can be more easily jetted towards a surface of a workpiece. The substantially water free solvent may comprise one or more of glycerol, methanol, ethanol, 1-propanol, 2-propanol, and/or propylene glycol.

In another embodiment, the substantially water free solvent comprises a combination of ethylene glycol and glycerol. The ratio of ethylene glycol to glycerol may be approximately 50:50 wt. %, often 70:30 wt. %, often 90:10 wt. %, often 95:5 wt. %.

The substantially water free ionic solvent may further comprise a quaternary ammonium salt. The incorporation of a quaternary ammonium salt into the substantially water free solvent has been found to improve the solubility of salts in the substantially water free solvent.

The substantially water free ionic solvent may comprise one or more of choline chloride, tetraethylammonium chloride and/or tetramethylammonium chloride.

The substantially water free ionic solvent may comprise a combination of ethylene glycol and choline chloride. That is, the substantially water free ionic solvent may be a deep eutectic solvent.

The substantially water free ionic solvent may comprise a ratio of polyol to quaternary ammonium salt in the range 1:2 to 1:5. Often the ratio of polyol to quaternary ammonium salt is in the range 1:3 to 1:4, often 1:3 to 1:4. The substantially water free ionic solvent may comprise a ratio of polyol to quaternary ammonium salt of approximately 1:3, but often this ratio may be 1:2, 1:4, or 1:5, or ratios in between.

The substantially water free ionic solvent may comprise a ratio of choline chloride to ethylene glycol in the range 1:2 to 1:5. Often the ratio of choline chloride to ethylene glycol is in the range 1:3 to 1:4, often 1:3 to 1:4. The substantially water free ionic solvent may comprise a ratio of choline chloride to ethylene glycol of approximately 1:3, but often this ratio may be 1:2, 1:4, or 1:5, or ratios in between.

TABLE 1
Table of conductivity of choline chloride:ethylene glycol
electrolyte solution without a viscosity modifier additive.

| Ratio Choline | Mass | Mass | Status | | |
|---|---|---|---|---|---|
| Chloride:Ethylene | (Choline | (Ethylene | (after | Conductivity | Temperature |
| Glycol | Chloride) | Glycol) | 3 days) | (mS/cm) | (° C.) |
| 1:1 | 17.4 | 7.8 | Solidified | N/A | N/A |
| 1:2 | 17.4 | 15.5 | Liquid | 8.9168 | 19.9 |
| | | | | (±0.00776) | |
| 1:3 | 17.4 | 23.3 | Liquid | 8.9632 | 19.9 |
| | | | | (±0.01165) | |
| 1:4 | 17.4 | 31.0 | Liquid | 8.8152 | 20.9 |
| | | | | (±0.00417) | |
| 1:5 | 17.4 | 38.8 | Liquid | 8.7424 | 21.0 |
| | | | | (±0.00280) | |
| 1:6 | 17.4 | 46.6 | Liquid | 8.0586 | 21.0 |
| | | | | (±0.00450) | |
| 0:1 (Pure | 0 | 7.8 | Liquid | 0.00028864 | 19.2 |
| Ethylene Glycol) | | | | | |

The conductivity of various compositions of the substantially water free ionic solvent are shown in Table 1. The conductivity of the substantially water free ionic solvent was found to be too low for effective machining of a surface of a workpiece in an electrochemical jet machining process.

The electrolyte solution for electrochemically machining surfaces also includes an ionisable material in the form of an inorganic salt. The addition of an inorganic salt to the electrolyte solution increases its conductivity, and so helps to facilitate the ionic transfer during the electrochemical machining process.

The electrolyte solution includes a viscosity modifier. This is provided so as to adjust the viscosity of the electrolyte solution to be within a specified range so as to facilitate jetting of the electrolyte solution (e.g. from a nozzle of an electrochemical machining device) towards a surface of workpiece. In an embodiment, the electrolyte solution comprises a viscosity in a predetermined range between 1 and 50 mPa·s at 20° C.

The viscosity modifier comprises a water-salt solution. The use of a water-salt solution as a viscosity modifier has been found to reduce the viscosity of the electrolyte solution whilst also increasing concentration of the ionisable material within the electrolyte solution (and so the conductivity of the solution).

The ionisable material within the electrolyte solution comprises inorganic salt compounds of the formula MX. M is selected from Na⁺, K⁺, Ca²⁺, Mg²⁺, Cu²⁺ and Zn²⁺, or combinations thereof. X is selected from F⁻, Cl⁻, Br⁻, I⁻, NO₃⁻ and SO₄²⁻, or combinations thereof. M will often by a group I metal, such as Na⁺ or K⁺ and X will often be a halogen, such as F⁻, Cl⁻, Br⁻, I⁻.

The water-salt solution in the electrolyte solution is a concentrated solution. The concentration of the saturated solution is at or close to the saturation point of the water-based inorganic salt solution. It will be appreciated that the saturation point of the water-salt solution will be dependent upon the salt used.

The concentration of the water-based inorganic salt solution may be in the range 80-100% of the concentrated solution, often in the range 90-100% of the concentrated solution, often in the range 95-100% of the concentrated solution. Put another way, the concentration of the water-based inorganic salt solution may be in the range 80-100% of the concentration point of the water-based inorganic salt solution, often in the range 90-100% of the concentration point of the water-based inorganic salt solution, often in the range 95-100% of the concentration point of the water-based inorganic salt solution.

The provision of concentration of the viscosity modifier at or close to the saturation point enables the concentration of salt within the electrolyte solution to be maximised whilst minimising the water content of the electrolyte solution. Further, utilising a solution concentration at or near (e.g. up to and not above) a saturation point provides a stable solution in which precipitation of the salt from the solution is prevented/minimised. This enables the salt solution to remain stable in storage. This also helps to prevent the introduction of unwanted particulates in the solution which could be detrimental to the jetting of an electrolyte solution.

In some arrangements, the water-salt solution in the electrolyte solution is of a molar concentration in the range 0.1M to 5M, often in the range 1M to 5M. Often, the molar concentration may be in the range 1M to 4M, for example. The molar concentration may be approximately 3M (for instance in the range 2.5M-3.5M or 2.9M-3.1M), but often the molar concentration may be 1M, often 2M, often 4M or often 5M.

As has been discussed above, water-based electrolyte solutions present problems when used in some electrochemical machining processes, as they can cause some metals and alloys, such as titanium and steel, to form passivated surfaces during the electrochemical machining process. Thus, even when a water-salt viscosity modifier is used in the electrolyte solution, the water content of the electrolyte solution should be constrained in order to be considered substantially water free.

The concentration of the viscosity modifier in the electrolyte solution (and so of water in the electrolyte solution) is generally less than 50 wt. %. Put another way, the concentration of the water-salt solution in the electrolyte solution is generally less than 50 wt. %. In some embodiments, the concentration of the viscosity modifier in the electrolyte solution may be in the range 0-50 wt. %, often 0.1-50 wt. %, often 1-50 wt. %, often 10-50 wt. %, often 20-50 wt. %.

It has been found that electrochemical machining carried out using electrolytes incorporating more than 50 wt. % of the viscosity modifier begin to encounter the problems associated with the traditional water-salt electrolyte solutions.

Often, the concentration of the viscosity modifier in the electrolyte solution (and so of water in the electrolyte solution) is less than 40 wt. %. Put another way, the concentration of the water-salt solution in the electrolyte solution is less than 40 wt. %. In some embodiments, the concentration of the viscosity modifier in the electrolyte solution may be in the range 0-40 wt. %, often 0.1-40 wt. %, often 1-40 wt. %, often 10-40 wt. %, often 20-40 wt. %.

Often, the concentration of the viscosity modifier in the electrolyte solution (and so of water in the electrolyte solution) is less than 30 wt. %. Put another way, the concentration of the water-salt solution in the electrolyte solution is less than 30 wt. %. In some embodiments, the concentration of the viscosity modifier in the electrolyte solution may be in the range 0-30 wt. %, often 0.1-30 wt. %, often 1-30 wt. %, often 10-30 wt. %, often 20-30 wt. %.

Often, the concentration of the viscosity modifier in the electrolyte solution (and so of water in the electrolyte solution) is less than 20 wt. %. Put another way, the concentration of the water-salt solution in the electrolyte solution is less than 20 wt. %. In some embodiments, the concentration of the viscosity modifier in the electrolyte solution may be in the range 0-20 wt. %, often 0.1-20 wt. %, often 1-20 wt. %, often 10-20 wt. %.

Often, the concentration of the viscosity modifier in the electrolyte solution (and so of water in the electrolyte solution) is less than 10 wt. %. Put another way, the concentration of the water-salt solution in the electrolyte solution is less than 10 wt. %. In some embodiments, the concentration of the viscosity modifier in the electrolyte solution may be in the range 0-10 wt. %, often 0.1-10 wt. %, often 1-10 wt. %, often 5-10 wt. %.

It will be appreciated that where the electrolyte solution has been defined in terms of the weight percentage of the viscosity modifier, the remainder of the electrolyte solution is provided by the substantially water free ionic solvent and the ionisable material.

The concentration of the substantially free ionic solvent may be at least 50 wt. %, often at least 60 wt. %, often at least 70 wt. %, often at least 75 wt. %, often at least 80 wt. %.

The concentration of the substantially free ionic solvent may be at least 50 wt. %. Put another way, the concentration of the substantially free ionic solvent may be in the range 50-99 wt. %, often 50-95 wt. %, often 50-90 wt. %, often 50-80 wt. %, often 50-70 wt. %, often 50-60 wt. %.

The concentration of the substantially free ionic solvent may be at least 60 wt. %. Put another way, the concentration of the substantially free ionic solvent may be in the range 60-99 wt. %, often 60-95 wt. %, often 60-90 wt. %, often 60-80 wt. %, often 60-70 wt. %.

The concentration of the substantially free ionic solvent may be at least 70 wt. %. Put another way, the concentration of the substantially free ionic solvent may be in the range 70-99 wt. %, often 70-95 wt. %, often 70-90 wt. %, often 70-80 wt. %.

The concentration of the substantially free ionic solvent may be at least 80 wt. %. Put another way, the concentration of the substantially free ionic solvent may be in the range 80-99 wt. %, often 80-95 wt. %, often 80-90 wt. %.

The concentration of the substantially free ionic solvent may be at least 90 wt. %. Put another way, the concentration of the substantially free ionic solvent may be in the range 90-99 wt. %, often 90-95 wt. %.

The conductivity of these electrolyte solutions is related to i) the amount dissolved inorganic salts, and ii) the viscosity. The addition of an ionisable material in a water-based viscosity modifier to the electrolyte solution increases the room temperature electrolytic conductivity of the electrolyte solution by i) increasing dissolved salt content and ii) lowering the viscosity. It will be appreciated that through elevating the temperature of the electrolyte solution, the viscosity will decrease and the electrical conductivity will increase. Therefore, increasing temperature will allow for less viscosity modifier, and so less water to be added to the electrolyte solution to obtain an equivalent conductivity/viscosity.

In order to be suitable for an electrochemical jet machining process, the electrolyte solution could usefully have a high conductivity. The electrolyte solution generally comprises an electrical conductivity of at least 10 mS/cm, often 10 mS/cm to 80 mS/cm, often 10 mS/cm to 70 mS/cm, often 10 mS/cm to 60 mS/cm, often 10 mS/cm to 50 mS/cm, often 10 mS/cm to 40 mS/cm, often 15 mS/cm to 35 mS/cm, often 20 mS/cm to 30 mS/cm.

In order to maintain the sustainability of the electrochemical jet processing/machining of a surface of a workpiece in an industrial setting, the electrolyte usefully should not be a highly toxic and/or a highly acidic/alkali solution. This also allows the electrolyte solution to maintain a low environmental impact solution. The electrolyte may be substantially neutral. Put another way, the pH of the electrolyte solution may be in the range of 5 to 9, or 6-8.

### Example 1

The conductivity of various compositions of the substantially water free ionic solvent are shown in Table 1. In order to increase the conductivity of the substantially water free ionic solvent an ionisable material was added to a substantially water free ionic solvent comprising a 1:3 ratio choline chloride:ethylene glycol solution.

A viscosity modifier comprising a 4M concentration of a sodium chloride water solution was added to the choline chloride:ethylene glycol solution. The concentration of the viscosity modifier was varied from 0 wt. % to 10 wt. %, 20 wt. %, 30 wt. %, 40 wt. % and 50 wt. %. The conductivity of the electrolyte solution having varying concentration of the viscosity modifier are shown in Table 2.

TABLE 2
Table of conductivity of choline chloride:ethylene glycol electrolyte
solution with varying concentration of a viscosity modifier.

| | Electrolytic Conductivity (mS/cm) |
|---|---|
| Choline Chloride:Ethylene Glycol | 8.422 ± 0.004 |
| (1:3) | |
| Choline Chloride:Ethylene Glycol | 12.950 ± 0.067 |
| (1:3) + 10 wt. % NaCl (4M) | |
| Choline Chloride:Ethylene Glycol | 17.900 ± 0.007 |
| (1:3) + 20 wt. % NaCl (4M) | |
| Choline Chloride:Ethylene Glycol | 23.613 ± 0.024 |
| (1:3) + 30 wt. % NaCl (4M) | |
| Choline Chloride:Ethylene Glycol | 29.000 ± 0.019 |
| (1:3) + 40 wt. % NaCl (4M) | |
| Choline Chloride:Ethylene Glycol | 35.655 ± 0.027 |
| (1:3) + 50 wt. % NaCl (4M) | |

A viscosity modifier comprising a 4M concentration of a sodium chloride water solution was added to the choline chloride:ethylene glycol solution. The concentration of the viscosity modifier was varied from 0 wt. % to 100 wt. % in 10 wt. % increments. The viscosity of the electrolyte solution at room temperature with varying concentration of the viscosity modifier are shown in Table 3.

TABLE 3
Table of viscosity of choline chloride:ethylene glycol electrolyte
solution with varying concentration of a viscosity modifier.

| | Viscosity (mPa · s) |
|---|---|
| Choline Chloride:Ethylene Glycol | 32.211 ± 0.319 |
| (1:3) | |
| Choline Chloride:Ethylene Glycol | 25.641 ± 1.296 |
| (1:3) + 10 wt. % NaCl (4M) | |
| Choline Chloride:Ethylene Glycol | 15.833 ± 0.142 |
| (1:3) + 20 wt. % NaCl (4M) | |
| Choline Chloride:Ethylene Glycol | 11.425 ± 0.214 |
| (1:3) + 30 wt. % NaCl (4M) | |
| Choline Chloride:Ethylene Glycol | 7.359 ± 0.177 |
| (1:3) + 41 wt. % NaCl (4M) | |
| Choline Chloride:Ethylene Glycol | 5.770 ± 0.108 |
| (1:3) + 51 wt. % NaCl (4M) | |
| 100 wt. % NaCl (4M) | 1.483 ± 0.016 |

### Example 2

A further example of an electrolyte solution for electrochemical machining processes comprises the following relative concentrations.

Ethylene glycol 40 wt. %. Choline chloride 30 wt. %. Viscosity modifier 30 wt. % (comprising: water 24.3 wt. %; and sodium chloride 5.7 wt. %).

This electrolyte solution has been found to be particularly advantageous when machining a titanium surface.

### Example 3

A further example of an electrolyte solution for electrochemical machining processes comprises the following relative concentrations.

A substantially water free ionic solvent comprising ethylene glycol in the range 50 to 55 wt. % and choline chloride in the range 40 to 45 wt. %.

The electrolyte solution may further include a viscosity modifier in the form of a water-based salt solution. The water-based salt solution may be in the range of 0.1 wt. % to 50 wt. %.

The salt may be sodium nitrate. The sodium nitrate may be up to 5 wt. % (in the range 0.1 to 5 wt. %) of the electrolyte solution.

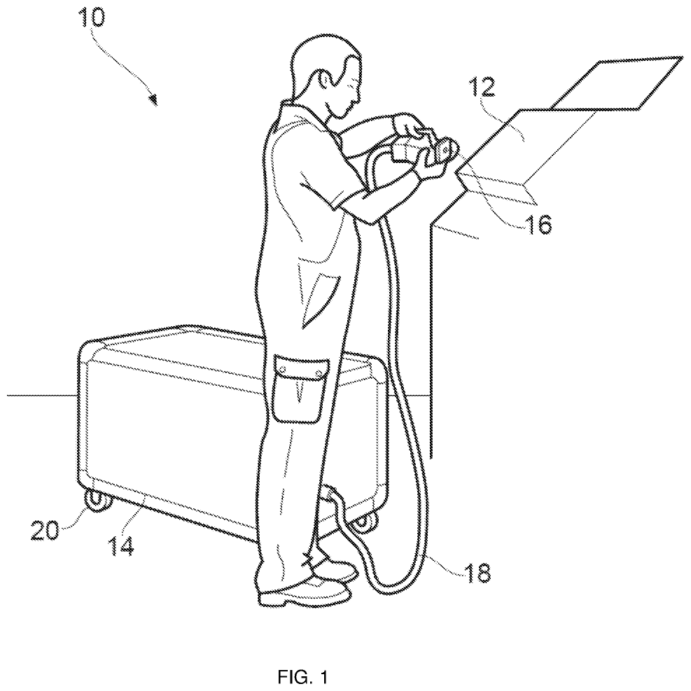

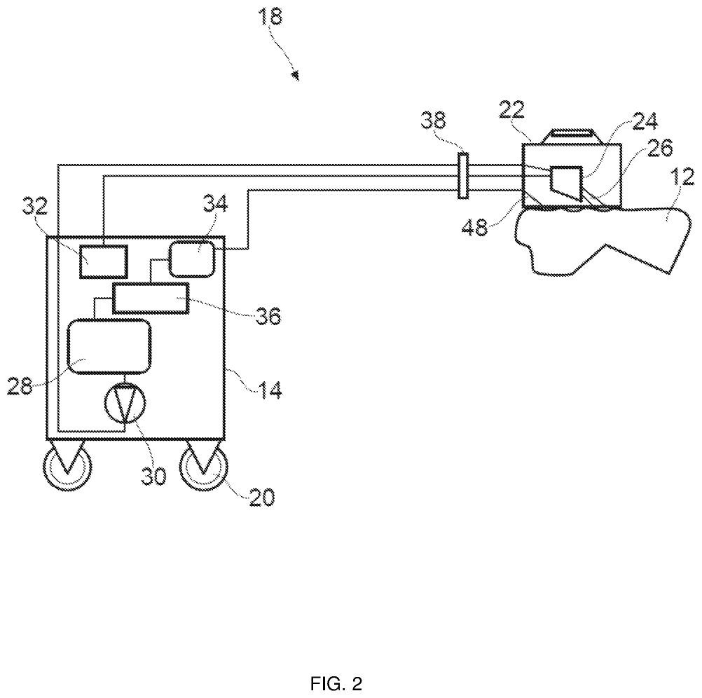

Referring to FIGS. 1 and 2, an electrochemical machining device 10 for carrying out an electrochemical machining process on a surface 12 of a workpiece is illustrated.

The electrochemical machining device 10 includes a base unit 14 and a hand-held machining unit 16. The base unit 14 and machining unit 16 are connected via an umbilical cord 18 through which the base unit 14 is able to supply power and electrolyte to the machining unit 16.

It will be appreciated that the machining unit 16 is designed to be operated either manually (as illustrated in FIG. 1) or as part of an automated process or to be operated remotely.

Referring to FIG. 2, the machining unit 16 is shown positioned on the surface 12 of a workpiece.

The machining unit 16 includes a housing 22. A nozzle 24 is positioned within the housing 22, and the nozzle 24 is configured to dispense an electrolyte jet 26 towards a surface 12 of a workpiece. In the present arrangement, the nozzle defines an area of 1 mm², but it will be appreciated that the nozzle area may be varied to suit the application. As illustrated, the housing 22 is configured to define an enclosed workspace when positioned against a surface 12 of a workpiece.

The electrochemical machining device 10 is configured to apply a charge to the nozzle 24 and the surface 12. In this way, the nozzle 24 and the surface 12 for first and second electrodes of an electrolytic cell. In alternative arrangements, the machining unit 16 may include an additional electrode, separate from the nozzle, and the electrochemical machining device may be configured to apply a charge to the additional electrode and the surface 12.

The electrochemical machining device 10 is intended to be used by an operator to carry out an electrochemical machining process for machining a surface of a workpiece. The machining process may include the steps of: i) dispensing a jet of an electrolyte solution according to any preceding claim from a nozzle of an electrochemical machining device towards a surface of a workpiece; and ii) applying a charge to a nozzle of an electrochemical machining device and applying a charge to a surface of a workpiece such that the nozzle and said surface define first and second electrodes of an electrolytic cell.

The electrochemical machining process may apply a current density below 400 A/cm². The electrochemical machining process may apply a current density below 150 A/cm². Often, the electrochemical machining process may apply a current density in the range 10 A/cm² to 400 A/cm², often 10 A/cm² to 150 A/cm², often 10 A/cm² to 100 A/cm², often 25 A/cm² to 100 A/cm², often 25 A/cm² to 75 A/cm², often 40 A/cm² to 60 A/cm², often approximately 50 A/cm².

Traditionally, lowering the current density can cause reductions to the surface quality of the machined surface. However, it has been found that by using an electrolyte solution as discussed above in an electrochemical machining process, a visibly smooth polished surface is able to be obtained by applying a current density of 50 A/cm².

The electrochemical machining device may be configured to apply a potential of less than 500 V. Often, the electrochemical machining device may apply a potential in the range 1V to 500 V.

Material removal and deposition is achieved by an electrolyte being supplied through the nozzle 24 and jetted towards the surface 12. An electrical potential is applied between the nozzle 24 and the surface 12 resulting in either anodic dissolution of the surface 12, or deposition onto the surface 12.

In a first mode of operation, a negative charge is applied to the nozzle 24 and a positive charge is applied to the surface 12. In this first mode of operation, the device 10 etches away at the surface 12 so as to modify the topography thereof. In a second mode of operation, a positive charge is applied to the nozzle 24 and a negative charge is applied to the surface 12. In this second mode of operation, material (e.g. such as silica particles or additive coatings to allow functionalisation of the surface) are able to be deposited onto the surface 12, which modifies the surface topography thereof.

The nozzle 24 is arranged within the housing 22 so as to be spaced apart from the surface 12, in use. The spacing between the electrode 24 and the workpiece surface 12 (i.e. the inter-electrode gap) affects the processing of the surface 12. The nozzle 24 is moveable within the housing 22 such that the spacing between the nozzle 24 and the surface 12 can be adjusted to suit a particular machining operation.

In order to be able to apply a charge to the nozzle 24 and the surface 12, the base unit 14 includes a power source 32 for supplying power to the machining unit 16 via the umbilical cord 18. It will be appreciated that in order to supply power to the machining unit 16, the power source 32 may include one or more batteries or may be connectable to an external power source.

Although the electrochemical jet processing of a material surface has been described with reference to the electrochemical machining device illustrated in FIGS. 1 and 2, it will be appreciated that the electrolyte solution discussed above may be utilised in any suitable electrochemical machining deice configured to dispense a jet of electrolyte solution towards a surface.

Although the teachings have been described above with reference to one or more embodiments, it will be appreciated that various changes or modifications may be made without departing from the scope as defined in the appended claims.

1. An electrolyte solution for an electrochemical machining process, the electrolyte solution comprising:
a substantially water free ionic solvent;
an ionisable material in the form of an inorganic salt; and
a viscosity modifier,
wherein the electrolyte comprises a viscosity in the range of 1 to 50 mPa·s at 20° C.

2. An electrolyte solution according to claim 1, wherein the viscosity modifier comprises a water-based inorganic salt solution.

3. An electrolyte solution according to claim 1, wherein the viscosity modifier is a saturated water-based inorganic salt solution.

4. An electrolyte solution according to claim 3, wherein the concentration of the saturated solution is at or close to the saturation point of the water-based inorganic salt solution.

5. An electrolyte solution according to claim 3, wherein the concentration of the saturated solution is in the range 80-100% of the saturation point of the water-based inorganic salt solution.

6. An electrolyte solution according to claim 2, wherein the inorganic salt water solution is of a molar concentration in the range 0.1M to 5M.

7. An electrolyte solution according to claim 1, wherein the concentration of the viscosity modifier in the electrolyte solution is less than 50 wt. %, optionally wherein the concentration of the viscosity modifier in the electrolyte solution is in the range 20 to 40 wt. %, for example approximately 30 wt. %.

8. An electrolyte solution according to claim 1, wherein the concentration of the substantially water free ionic solvent is at least 50 wt. %, optionally at least 60 wt. %, for example approximately 70 wt. %.

9. An electrolyte solution according to claim 1, wherein the ionisable comprises compounds of the formula MX, where M is selected from Na⁺, K⁺, Ca²⁺, Mg²⁺, Cu²⁺ and Zn²⁺, or combinations thereof, and X is selected from F⁻, Cl⁻, Br⁻, I⁻, NO₃⁺ and SO₄²⁻, or combinations thereof.

10. An electrolyte solution according to claim 1, wherein the substantially water free solvent comprises a polyol, optionally wherein the substantially water free solvent is selected from ethylene glycol, glycerol, methanol, ethanol, 1-propanol, 2-propanol and/or propylene glycol.

11. An electrolyte solution according to claim 10, wherein the substantially water free solvent is selected from ethylene glycol and/or glycerol.

12. An electrolyte solution according to claim 1, wherein the substantially water free solvent comprises a quaternary ammonium salt, optionally wherein the quaternary ammonium salt is selected from one or more of choline chloride, tetraethylammonium chloride and/or tetramethylammonium chloride.

13. An electrolyte solution according to claim 1, wherein the substantially water free solvent is a deep eutectic solvent comprising ethylene glycol and choline chloride.

14. An electrolyte solution according to claim 13, wherein the substantially water free ionic solvent comprises a ratio of choline chloride to ethylene glycol in the range 1:2 to 1:5, optionally wherein the substantially water free ionic comprises a ratio of choline chloride to ethylene glycol of approximately 1:3.

15. An electrolyte solution according to claim 1, wherein the pH of the electrolyte solution is in the range of 5 to 9.

16. An electrolyte solution according to claim 1, wherein the electrolyte comprises a viscosity in the range 5 to 30 mPa·s at 20° C., optionally wherein the electrolyte comprises a viscosity in the range 10 to 15 mPa·s at 20° C.

17. An electrolyte solution according to claim 1, wherein the electrolyte solution comprises an electrical conductivity of at least 10 mS/cm.

18. An electrolyte solution according to claim 17, wherein the electrolyte solution comprises an electrical conductivity in the range 10 mS/cm to 40 mS/cm, optionally wherein the electrolyte solution comprises a conductivity in the range 20 mS/cm to 30 mS/cm.

19. An electrochemical machining process for machining a surface of a workpiece using an electrochemical machining device comprising a nozzle configured for dispensing a jet of an electrolyte solution towards a surface of a workpiece, the electrochemical machining process comprising the steps of:
dispensing a jet of an electrolyte solution according to claim 1 from a nozzle of an electrochemical machining device towards a surface of a workpiece; and
applying a charge to a nozzle of an electrochemical machining device and applying a charge to a surface of a workpiece such that the nozzle and said surface define first and second electrodes of an electrolytic cell.

20. An electrochemical machining process according to claim 19, wherein the process applies a current density below 400 A/cm², optionally below 150 A/cm², optionally below 100 A/cm², for example in the range of 25 to 100 A/cm².
